(19) United States
(12) Patent Application Publication
(10) Pub. No.: US 2026/0360701 A1
(43) Pub. Date: Nov. 12, 2026

(54) A LITHIUM SECONDARY ELECTROCHEMICAL CELL FOR AVIATION APPLICATIONS

(71) Applicant: SAFT, Levallois-Perret (FR)

(72) Inventors: Serena PETERSON, Cockeysville, MD (US); Jean-Paul PERES, EYSINES (FR); Erwan DUMONT, AMBARES ET LAGRAVE (FR); Rodolphe BOULAIS, Lake Park, GA (US); Lianxi YANG, Lutherville Timonium, MD (US); Cécile TESSIER, BRUGES (FR); Patrick BERNARD, BORDEAUX (FR); Carine STEINWAY, Newtonville, MA (US); Xilin CHEN, Lutherville Timonium, MD (US); Sylvie HERREYRE, SAINT-ANDRE-DE-CUBZAC (FR); Thomas GRESZLER, Phoenix, MD (US); Bernard SIMON, LE TAILLAN MEDOC (FR)

(73) Assignee: SAFT, Levallois-Perret (FR)

(21) Appl. No.: 19/121,209

(22) PCT Filed: Nov. 9, 2023
(86) PCT No.: PCT/EP2023/081271

§ 371 Date: Apr. 15, 2025

(30) Foreign Application Priority Data
Nov. 17, 2022 (FR) FR2211985

(51) Int. Cl. H01M 4/36; B64D 27/33; B64D 27/34; B64D 27/357; H01M 4/02; H01M 4/38; H01M 4/525; H01M 4/58; H01M 4/583; H01M 4/62; H01M 4/66; H01M 4/75

(52) U.S. Cl. CPC H01M 4/364; B64D 27/33; B64D 27/34; B64D 27/357; H01M 4/386; H01M 4/525; H01M 4/5825; H01M 4/583; H01M 4/625; H01M 4/662; H01M 4/663; H01M 4/667; H01M 4/75; H01M 2004/027; H01M 2004/028

(57) ABSTRACT

An electrochemical pouch cell (1) including positive and negative electrodes, wherein the positive electrode includes a composition of positive active materials, including a blend of: a) from 30 to 50 wt. % of a lithium manganese iron phosphate of formula LixMn1-y-zFeyMzPO4 where 0.8≤x≤1.2; 0.5≤(1-y-z)<1; 0<y≤0.5; 0≤z≤0.2; M selected from the group of B, Mg, Al, Si, Ca, Ti, V, Cr, Co, Ni, Cu, Zn, Y, Zr, Nb, Mo, and mixtures thereof, b) from 70 to 50 wt. % of a lithium nickel oxide selected from Liw(NixCoyAlzMt)O2 where 0.9≤w≤1.1; 0<x; 0<y; 0<z; 0≤t; M selected from B, Mg, Si, Ca, Ti, V, Cr, Mn, Fe, Cu, Zn, Y, Zr, Nb, W, Mo, and mixtures thereof and Liw(NixMnyCozMt)O2 where 0.9≤w≤1.1; 0<x; 0<y; 0<z; 0≤t; M selected from Al, B, Mg, Si, Ca, Ti, V, Cr, Fe, Cu, Zn, Y, Zr, Nb, W, Mo, and mixtures thereof.

### FIELD OF THE INVENTION

The invention pertains to the technical field of lithium secondary (rechargeable) electrochemical cells suitable for use in flying vehicles, specifically electrically powered flying vehicles and hybrid-electric-powered flying vehicles.

### BACKGROUND OF THE INVENTION

Electric battery-powered flying-vehicles (BEV) and hybrid-electric-powered flying-vehicles (HEV) can reduce aircraft polluting emissions. They are entering mainstream aviation markets. These flying vehicles require batteries exhibiting a high specific power, a high specific energy and a high operating safety. It would be desirable to provide an electrochemical cell which would meet the three following requirements:
1) a high specific energy of at least 250 Wh/kg,
2) a high specific power of at least 1000 W/kg, even for a low state of charge, e.g., 20%. (As a comparison, the specific power requirement for an electrochemical cell intended to be used in the automotive field is only 500 W/kg).
3) a high operating safety when the cell is exposed to a temperature beyond the nominal limits. The European Council for Automotive R&D (EUCAR) has established a scale ranging from 0 to 7 to quantify the level of hazard associated with the use of batteries, level 0 corresponding to the lowest risk, level 7 corresponding to the highest risk. An electrochemical cell intended to be used in aviation application should meet the EUCAR 4 safety test or lower.

An electrochemical cell fulfilling only one of three above requirements can be easily designed, but a cell fulfilling the three requirements altogether cannot be easily designed. For example, a cell exhibiting a specific energy of more than 250 Wh/kg can be made but it will not pass the safety test. A cell exhibiting a specific power of more than 1000 W/kg can also be made, but it will not meet the specific energy requirement or the safety requirement.

A cathode for which the active material consists only of a lithium nickel manganese cobalt oxide (NMC) or of a lithium nickel cobalt aluminum oxide (NCA) does not meet the requirement of high operating safety. Indeed, it is known that nickel-rich lithium oxides are not stable at high temperature, typically above 100 °C. To address the lack of stability of these oxides, it has been proposed to blend them with a material with greater thermal stability, such as a lithium manganese iron phosphate of the general formula LiₓMn_{1-y-z}Fe_{y}M_{z}PO₄ (LMFP) where 0.8≤x≤1.2; 0.5≤1-y-z<1; 0<y≤0.5; 0≤z≤0.2 and M is a doping chemical element. The LMFP compound improves the thermal stability of the electrode. However, it has an insufficient specific capacity so that, to the best of applicant's knowledge, existing cells with a positive electrode containing a blend of LMFP and a lithium nickel oxide have a specific energy of less than 250 Wh/kg. Further, to the applicant's knowledge, existing electrochemical cells of 250 Wh/kg specific energy density or above are rated 6 or 7 on the EUCAR scale.

In conclusion, an electrochemical cell having a positive electrode containing a blend of LMFP and a lithium nickel oxide is sought that has a specific energy of at least 250 Wh/kg, a specific power of at least 1000 W/kg and that passes the EUCAR 4 safety test or lower.

Document WO-A-2021/259991 describes a composition of active materials comprising a blend consisting of 50-90% by mass of LMFP and 10-50% by mass of a lithium nickel oxide for an electrode of a cell intended to be used in the automotive field.

Document WO-A-2016/184896 describes a composition of active materials comprising a majority of a LMFP compound characterized by a volume median diameter of particles Dᵥ₅₀² greater than or equal to 500 nm and a minority of an NMC compound having a volume median particle diameter Dᵥ₅₀¹ greater than or equal to 500 nm, and wherein the ratio Dᵥ₅₀²/Dᵥ₅₀¹ is greater than or equal to 1.5.

### SUMMARY OF THE INVENTION

The invention provides a secondary electrochemical cell satisfying the above three requirements. The electrochemical pouch cell comprises at least one positive electrode and at least one negative electrode, the positive electrode comprising a layer of a composition of positive active materials, said composition comprising a blend of:
a) from 30 to 50 wt. % of a lithium manganese iron phosphate of formula LiₓMn_{1-y-z}Fe_{y}M_{z}PO₄ where 0.8≤x≤1.2; 0.5≤(1-y-z)<1; 0<y≤0.5; 0≤z≤0.2;
M being selected from the group consisting of B, Mg, Al, Si, Ca, Ti, V, Cr, Co, Ni, Cu, Zn, Y, Zr, Nb, Mo, and mixtures thereof,
b) from 70 to 50 wt. % of at least one lithium nickel oxide selected from Li_{w}(NiₓCO_{y}Al_{z}Mₜ)O₂ where 0.9≤w≤1.1; 0<x; 0<y; 0<z; Ost; M being selected from the group consisting of B, Mg, Si, Ca, Ti, V, Cr, Mn, Fe, Cu, Zn, Y, Zr, Nb, W, Mo, and mixtures thereof, and
Li_{w}(NiₓMn_{y}Co_{z}Mₜ)O₂ where 0.9≤w≤1.1; 0<x; 0<y; 0<z; Ost; M being selected from the group consisting of Al, B, Mg, Si, Ca, Ti, V, Cr, Fe, Cu, Zn, Y, Zr, Nb, W, Mo, and mixtures thereof, and wherein the positive electrode porosity is less than or equal to 40%, and the negative electrode porosity is less than or equal to 30%.

The invention is based on the discovery that by decreasing the porosity of a positive electrode containing a blend of LMFP and a lithium nickel oxide to a value of 40% or less, and by decreasing the porosity of the associated negative electrode to a value of 30% or less, and by selecting the pouch format, it was possible to obtain a cell having a high specific energy of 250 Wh/kg or more, a high specific power of more than 1000 W/kg, even at low states of charge of about 20%, and which complies with the requirements of the EUCAR 4 test or lower, especially in the nail test and the overheating test.

In one embodiment, the lithium nickel oxide is Li_{w}(NiₓMn_{y}Co_{z}Mₜ)O₂ with 0.7≤x, preferably 0.8≤x.

In one embodiment, secondary particles of the lithium nickel oxide have a first volume median diameter Dᵥ₅₀¹ and secondary particles of the lithium manganese iron phosphate have a second volume median diameter Dᵥ₅₀², the ratio Dᵥ₅₀¹/Dᵥ₅₀² being from 2 to 9, preferably from 3 to 7.

In one embodiment, the positive electrode comprises a current collector which is an aluminum foil or an aluminum alloy foil at least partially covered on one or both sides with a coating. The coating may be made of a material selected from the group consisting of carbon, graphite, carbon nanotubes and a mixture thereof.

In one embodiment, the current collector has a thickness in the range of from 5 to 20 μm, preferably from 10 to 16 μm.

In one embodiment, the negative electrode comprises a current collector having a thickness in the range of from 3 to 10 μm, preferably from 5 to 8 μm.

In one embodiment, the layer of the composition of positive active materials contains one or more binders and/or one or more electronic conductive material and the mass of said one or more binders represents 1% or less of the mass of the layer; the mass of said one or more electronic conductive material represents 1% or less of the mass of the layer.

In one embodiment, the layer of the composition of positive active materials contains carbon nanotubes.

In one embodiment, said at least one negative electrode comprises a layer of a composition of negative active materials, said composition comprising a blend of at least one anisotropically grown carbon with at least one isotropically grown carbon.

In one embodiment, the mass of the isotropically grown carbon represents from 10 to 60% or from 20 to 50% of the mass of the blend.

In one embodiment, the composition of negative active materials further comprises a silicon-based compound.

Another object of the invention is a battery comprising a plurality of electrochemical pouch cells as described above.

Another object of the invention is a flying vehicle powered by the battery.

In one embodiment, the flying vehicle is an electrically powered flying vehicle or a hybrid-electric-powered flying vehicle.

In one embodiment, the electrically powered flying vehicle or the hybrid-powered flying vehicle is selected from the group consisting of:
an electric vertical take-off and landing vehicle (e-VTOL),
an electric conventional take-off and landing vehicle (e-CTO), and
an electric short take-off and landing vehicle (e-STOL).

In one embodiment, the flying vehicle is an aircraft.

### BRIEF DESCRIPTION OF THE DRAWINGS

FIG. 1 represents schematically an external view of a pouch cell.

FIG. 2 represents the percentage of the reference discharged capacity as a function of the discharge rate. The capacity discharged at a C/10 rate is taken as the reference discharged capacity.

### DETAILED DESCRIPTION OF THE INVENTION

### Structure of the Pouch Electrochemical Cell

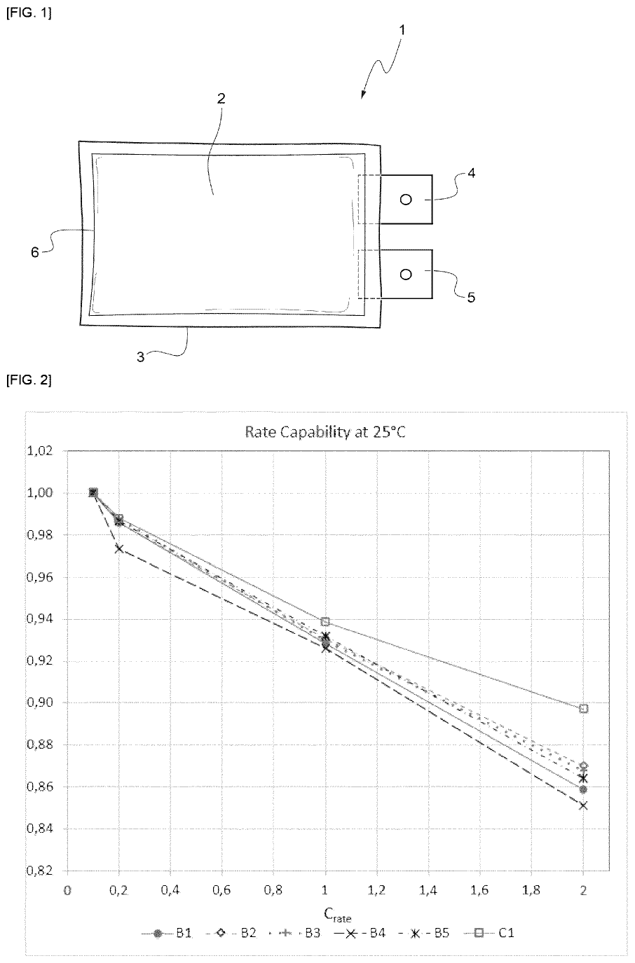

A first requirement to achieve the above objectives is to manufacture a cell in the pouch format. Other formats such as the cylindrical format or the parallelepiped format do not allow obtaining a cell which satisfies the three above requirements. To manufacture a pouch cell, a stack of at least one positive electrode, a separator and at least one negative electrode is assembled. This assembly is inserted inside a flexible pouch. The pouch is formed beforehand by welding the edges of two multilayer films, each multilayer film comprising a metal layer, generally aluminum, sandwiched between two layers of plastic material. A portion of the positive current collector of the positive electrode located in the vicinity of one edge of the positive electrode is not coated with positive active materials. Said current collector portion not coated with positive active materials serves for connection to a positive current output terminal. Similarly, a portion of the negative current collector of the negative electrode located in the vicinity of one edge of the negative electrode is not coated with negative active materials. Said current collector portion not covered with negative active materials serves for connection to a negative current output terminal. The positive current output terminal and the negative current output terminal extend out of the volume of the pouch, and generally protrude from the same edge of the pouch. They may also project from two opposite edges of the pouch. The pouch is filled with an electrolyte and then hermetically sealed. FIG. 1 shows schematically an external view of a pouch cell (1). A plate pack (2) consisting of a positive electrode, a negative electrode and a separator is housed in a rectangular pouch (3). The positive (4) and negative (5) current output terminals protrude from one edge of the pouch. A line of heat seal (6) extends along all the four edges of the pouch to hermetically seal the pouch.

### Positive Electrode:

The at least one positive electrode comprises a positive current collector having at least one of its two sides coated with a layer of a composition of positive active materials. By composition of active materials there is meant a composition comprising one or more active materials and optionally one or more binders and one or more electronic conductive materials.

The positive current collector is a solid or perforated metal foil which may be made of aluminum or an aluminum alloy or steel or stainless steel. Its thickness may range from 6 to 30 μm or from 5 to 20 μm or from 10 to 15 μm, preferably from 10 to 15 μm. A small thickness makes it possible to increase the mass of the layer of the composition of positive active materials and to achieve the desired specific energy and specific power.

Before coating the current collector with the layer of the composition of active materials, the current collector may be coated on one or on both of its sides with a coating intended to improve the electronic conductivity between the layer of the composition of active materials and the foil and/or to improve the adhesion of the layer of the composition of active materials to the foil. The coating material may be selected from the group consisting of carbon, graphite, carbon fibers, carbon nanotubes, and a mixture thereof. Preferably, it is made of carbon. The coating material may cover totally or partially one or both sides of the foil. The coating material may be obtained by coating the foil with a dispersion of the material and then evaporating the solvent of the dispersion or it may be obtained by sputtering. Portions of the current collector may be coated with the coating material. The coated portions may be separated from each other by predetermined or periodic intervals (“intermittent coating”). The intermittent coating is preferably present on both sides of the current collector. It facilitates electrode processing. Alternatively, one or both surfaces of the foil may have undergone a surface treatment to increase the adhesion of the layer of composition of active materials to the foil. This may be a surface treatment creating asperities or a microroughness, such as a physical or chemical etching or a laser treatment.

The composition of positive active materials comprises a blend consisting of:
a) from 30 to 50 wt. % of a lithium manganese iron phosphate of formula LiₓMn_{1-y-z}Fe_{y}M_{z}PO₄ (LMFP) where 0.8≤x≤1.2; 0.5≤(1-y-z)<1; 0<y≤0.5; 0≤z≤0.2; M being selected from the group consisting of B, Mg, Al, Si, Ca, Ti, V, Cr, Co, Ni, Cu, Zn, Y, Zr, Nb, Mo, and mixtures thereof,
b) from 70 to 50 wt. % of at least one lithium nickel oxide selected from Li_{w}(NiₓCO_{y}Al_{z}Mₜ)O₂ (NCA) where 0.9≤w≤1.1; 0<x; 0<y; 0<z; Ost; M being selected from the group consisting of B, Mg, Si, Ca, Ti, V, Cr, Mn, Fe, Cu, Zn, Y, Zr, Nb, W, Mo, and mixtures thereof, and
Li_{w}(NiₓMn_{y}Co_{z}Mₜ)O₂ (NMC) where 0.9≤w≤1.1; 0<x; 0<y; 0<z; Ost; M being selected from the group consisting of Al, B, Mg, Si, Ca, Ti, V, Cr, Fe, Cu, Zn, Y, Zr, Nb, W, Mo, and mixtures thereof.

The lithium nickel oxide may be in the form of a single crystal or of a multi-crystal.

It may be a blend of LMFP, NCA and/or NMC. Preferably, the composition of active materials does not contain other active materials than LMFP, NCA and/or NMC. Preferably, the blend of active materials consists of LMFP and NMC.

The blend may consist of:
from 30 to 45% or from 30 to 40% or from 30 to 35% of LMFP,
from 70 to 55% or from 70 to 60% or from 70 to 65% of the at least one lithium nickel oxide.

The blend may consist of:
from 35 to 50% or from 35 to 45% or from 35 to 40% of LMFP,
from 65 to 50% or from 65 to 55% or from 65 to 60% of the at least one lithium nickel oxide.

The blend may consist of:
from 40 to 50% or from 40 to 45% of LMFP,
from 60 to 50% or from 60 to 55% of the at least one lithium nickel oxide.

LMFP may be coated with carbon or with carbon nanotubes.

According to one embodiment, in LMFP, 0.5<1-y-z<1 or 0.7≤1-y-z≤0.9 or 0.75≤1-y-z≤0.80.

Examples of LMFP type compounds are LiMn_{0.8}Fe_{0.2}PO₄, LiMn_{0.78}Fe_{0.22}PO₄, LiMn_{0.7}Fe_{0.3}PO₄, LiMn_{2/3}Fe_{1/3}PO₄ and LiMn_{0.5}Fe_{0.5}PO₄.

With respect to the NMC compound, preferably 0.6≤x or 0.7≤x or 0.8≤x. Preferred examples of NMC compounds are LiNi_{0.7}Mn_{0.2}Co_{0.1}O₂ (NMC 721) and LiNi_{0.8}Mn_{0.1}Co_{0.1}O₂ (NMC 811).

With respect to the NCA compound, preferably 0.6≤x or 0.7≤x or 0.8≤x. Examples of NCA compounds are LiNi_{0.84}Co_{0.08}Al_{0.08}O₂, LiNi_{0.85}Co_{0.10}Al_{0.05}O₂, LiNi_{0.87}Co_{0.06}Al_{0.07}O₂, and LiNi_{0.89}Co_{0.06}Al_{0.05}O₂.

For both NMC and NCA, a high stoichiometric index of nickel makes it possible to obtain a positive electrode having a high specific energy.

The following blends are particularly preferred:
1) 50% LMFP/50% NMC wherein x in NMC is equal to or greater than 0.8,
2) 40% LMFP/60% NMC wherein x in NMC is equal to or greater than 0.8,
3) 50% LMFP/50% NCA wherein x in NCA is equal to or greater than 0.8,
4) 40% LMFP/60% NCA wherein x in NCA is equal to or greater than 0.8.

Blends 2 and 4 achieve a good discharge performance under a high current.

Both the lithium manganese iron phosphate and the lithium nickel oxide may be either in the form of disjointed particles, also called primary particles, or in the form of agglomerated particles, also called secondary particles. A particle population is characterized by its size distribution. One parameter characterizing a size distribution is the median volume diameter Dv₅₀. The term “median volume diameter Dv₅₀” means that in one given population of particles 50% of the volume of the particles consists of particles having an equivalent diameter of less than the value Dv₅₀ and 50% of the volume of the particles consists of particles having an equivalent diameter equal to or greater than the value Dv₅₀. The term “equivalent diameter” of a particle designates the diameter of a sphere having the same volume as this particle. The volume median diameter can be measured by laser diffraction.

The lithium nickel oxide may be a multi-crystal and may be in the form of secondary particles having a volume median diameter Dv₅₀¹ ranging from 8 to 15 μm or from 8 to 13 μm. In one embodiment, the lithium nickel oxide is a multi-crystal NMC wherein x in NMC is equal to or greater than 0.8 and which forms secondary particles having a Dv₁₀¹ in the range of 4-7 μm, a Dv₅₀¹ in the range of 8-10 μm and a Dv₉₀¹ in the range of 15-20 μm. Dv₁₀¹ refers to a population of particles in which 10% of the volume of the particles consists of particles having an equivalent diameter of less than the value Dv₁₀¹ and 90% of the volume of the particles consists of particles having an equivalent diameter equal to or greater than the value Dv₁₀¹. Dv₉₀¹ refers to a population of particles in which 90% of the volume of the particles consists of particles having an equivalent diameter of less than the value Dv₉₀¹ and 10% of the volume of the particles consists of particles having an equivalent diameter equal to or greater than the value Dv₉₀¹.

LMFP may be in the form of secondary particles having a volume median diameter Dᵥ₅₀² in the range of 1 μm to 5 μm or from 1.5 to 4 μm.

Preferably, the particle sizes of the active materials are chosen such that the Dv₅₀¹/Dv₅₀² ratio ranges from 2 to 9 or from 3 to 7 or from 3 to 5.

The binder generally used in the composition of active materials reinforces the cohesion between the particles of active materials and improves the adhesion of the layer of the composition of active materials to the current collector. The binder may contain one or more of the following compounds: polyvinylidene fluoride (PVDF) and its copolymers, polytetrafluoroethylene (PTFE) and its copolymers, polyacrylonitrile (PAN), poly(methyl)- or (butyl) methacrylate, polyvinyl chloride (PVC), poly(vinyl formal), polyester, block polyetheramides, polymers of acrylic acid, methacrylic acid, acrylamide, itaconic acid, sulfonic acid, elastomers, and cellulosic compounds such as carboxymethylcellulose (CMC). The elastomers that can be used as a binder may be selected from styrene-butadiene (SBR), butadiene-acrylonitrile (NBR), hydrogenated butadiene-acrylonitrile (HNBR). The binder may represent from less than 1% to 10% or from 1 to 5% or from 2 to 5% of the mass of the dry composition of active materials.

The electronic conductive material is generally selected from graphite, carbon black, acetylene black, soot, graphene, carbon fibers, single-wall carbon nanotubes, multi-wall carbon nanotubes or a mixture thereof. It may represent from less than 1 to 10% or from 1 to 5% or from 2 to 5% of the mass of the dry composition of active materials.

### Preparation of the Positive Electrode:

An ink is prepared by dispersing LMFP and at least one of NCA and NMC in a solvent or in a mixture of several solvents. Optionally a binder and an electronic conductive material are added to the dispersion. By varying the amount of solvent incorporated into the mixture, the viscosity of the ink may be varied before it is deposited on one side of the current collector. The ink-coated current collector is dried and then rolled to adjust its thickness. After evaporation of the solvent(s), a layer of a composition of active materials is obtained, the proportions of the various constituents of which are typically:
from 75 to 98% by mass of positive active materials, or from 90 to 95%,
from 1 to 10% by mass of binder(s) or from 2-5%,
from 1 to 10% by mass of electronic conductive material, or from 2-5%.

Typically, the mass of the composition of the positive active materials deposited can be in the range from 20 to 30 mg/cm²/per face or from 25 to 30 mg/cm²/per face.

The positive electrode is characterized by a porosity less than or equal to 40%, or less than or equal to 35%, or less than or equal to 30% or less than equal to 25%.

Mixing LMFP with at least one lithium nickel oxide, preferably NMC, in the prescribed proportions of 30-50% of LMFP/70-50% of nickel oxide allows achieving a porosity of less than or equal to 40%, which in turn improves the cell energy density. Other process conditions which are helpful for further decreasing the porosity are as follows:
coating the current collector, preferably on both sides, with an intermittent coating as described above before depositing the ink;
selecting a Dv₅₀¹/Dv₅₀² higher than or equal to 3, preferably higher than or equal to 5;
decreasing the content of carbon black or even replacing it by a less porous electronic conductive material such as graphite, carbon nanotubes or graphene.

The electrode porosity for both the positive and the negative electrode is defined as the percentage of the volume of the pores to the geometric volume of the electrode. The volume of the pores encompasses the volume of the void present between the particles of the compounds in the layer deposited on the current collector and the volume of the pores inside the particles of the compounds in the layer deposited on the current collector. The pores inside the particles encompass the accessible pores and the inaccessible pores. The electrode porosity may be obtained through the two following methods:
In a first method, the mercury technique is used to determine the volume of the pores. The geometric volume of the electrode is obtained by multiplying the thickness of the layer deposited on the current collector by the area coated by the layer. The porosity is obtained by calculating the ratio between the volume of the pores and the geometric volume of the electrode.
In a second method, the theoretical density dₜᵣᵤₑ is calculated starting from the density of each compound in the layer deposited in the current collector. The bulk density d_{bulk} is calculated knowing the mass and the volume of the layer deposited on the current collector. The relationship which links the porosity with the true density and with the bulk density is: Porosity=1−(d_{bulk}/dₜᵣᵤₑ).

### Negative Electrode:

The at least one negative electrode comprises a negative current collector at least one of its two sides being coated with a layer of a composition of negative active materials. The composition of negative active materials comprises at least one negative active material and optionally a binder and an electronic conductive material. The negative current collector is a solid or a perforated metal foil which may be made of copper or a copper-based alloy. Its thickness may range from 3 to 10 μm, preferably from 5 to 8 μm. A small current collector thickness makes it possible to increase the mass of the layer of the composition of the negative active materials and to achieve the desired specific energy and specific power.

The at least one negative active material is preferably chosen from carbon, graphite, coke, carbon black, and glassy carbon.

Preferably, the negative active material is a blend of at least one anisotropically grown carbon, also called “soft” carbon, with at least one isotropically grown carbon, also called “hard” carbon.

The anisotropically grown carbon may be in the form of elongated platelets. It may be in a crystallized form. The anisotropically grown carbon may be a modified artificial graphite. The anisotropically grown carbon may be a mixture of a modified artificial graphite and a surface-coated modified artificial graphite.

The isotropically grown carbon may be a highly pyrolytic graphite (HPG). The mass of the isotropically grown carbon may represent from 10 to 60% or from 20 to 50% or about 40% of the mass of the blend.

The mass of the anisotropically grown carbon may represent from 90 to 40% of from 80 to 50% or about 60% of the mass of the blend.

The mass of the modified artificial graphite may represent from 20 to 40% of the mass of the blend.

The mass of the surface-coated modified artificial graphite may represent from 20 to 40% of the mass of the blend.

One preferred example of a negative active material is a blend consisting of:
30% of a modified artificial graphite,
30% of a surface-coated modified artificial graphite,
40% of a highly pyrolytic graphite.

Both the anisotropically grown carbon and the isotropically grown carbon may exhibit a particle size distribution characterized by a Dv₅₀ in the range of from 5 to 30 μm or from 10 to 25 μm or from 15 to 25 μm.

The blend of the at least one anisotropically grown carbon with the at least one isotropically grown carbon allows to take advantage of the good calendaring ability of the anisotropically grown carbon to decrease porosity, while preventing shrinkage of the negative electrode structure using the isotropically grown carbon as pillars. As a result, the electrode exhibits both a low porosity, e.g., less than or equal to 30%, and a low tortuosity. This blend also allows reducing the electrode ionic resistivity by a factor of 2 with respect to a negative active material consisting only of an isotropically grown carbon. Further, lithium plating at the electrode surface is reduced or prevented. The composition of the negative active materials may further comprise a silicon-based compound.

### Method of Preparation of the Negative Electrode:

The negative electrode is prepared in a conventional manner. An ink is prepared by dispersing in a solvent or in a mixture of solvents one or more negative active materials, optionally with a binder. The binder can be such as those described in connection with the positive electrode.

The current collector coated with ink is dried and then rolled in order to adjust its thickness. A negative electrode is thus obtained.

Typical proportions of the components of the layer of composition of negative active materials, after evaporation of the solvent contained in the ink, are:
from 75 to 98% by mass of negative active materials, or from 90 to 98%,
from 1 to 10% by mass of binder(s), or from 1 to 5%,
from 0 to 5% by mass of an electronic conductive material, of from 1-5%.

The negative electrode is characterized by a porosity less than or equal to 30%.

### Electrolyte:

The electrolyte can be liquid. It is obtained by dissolving one or more lithium salts in one or more organic solvents. The solvent can be selected from saturated cyclic carbonates, unsaturated cyclic carbonates, non-cyclic carbonates, alkyl esters, ethers, nitrile solvents and tetrahydrothiofen dioxide (sulfolane).

Saturated cyclic carbonates include ethylene carbonate (EC), fluoroethylene carbonate (FEC), propylene carbonate (PC), butylene carbonate (BC), and mixtures thereof.

Unsaturated cyclic carbonates include vinylene carbonate (VC).

Non-cyclic carbonates include dimethyl carbonate (DMC), diethyl carbonate (DEC), methyl ethyl carbonate (EMC), dipropyl carbonate (DPC), and mixtures thereof.

Alkyl esters include methyl acetate, ethyl acetate, methyl propionate, ethyl propionate, butyl propionate, methyl butyrate, ethyl butyrate, propyl butyrate, and mixtures thereof.

Ethers include dimethyl ether (DME), diethyl ether (DEE), and mixtures thereof.

The lithium salt can be selected from lithium perchlorate LiClO₄, lithium hexafluorophosphate LiPF₆, lithium tetrafluoroborate LiBF₄, lithium hexafluoroarsenate LiAsF₆, lithium hexafluoroantimonate LiSbF₆, lithium trifluoromethanesulfonate LiCF₃SO₃, lithium bis(fluorosulfonyl)imide Li(FSO₂)₂N (LiFSI), lithium bis(trifluoromethanesulfonyl)imide LiN(CF₃SO₂)₂ (LiTFSI), lithium tris(fluoromethanesulfonyl)methylide LiC(CF₃SO₂)₃ (LiTFSM), le bis(pentafluoroethylsulfonyl)imidure de lithium LiN(C₂F₅SO₂)₂ (LiBETI), lithium 4,5-dicyano-2-(trifluoromethyl)imidazolide (LiTDI), lithium bis(oxalato)borate (LiBOB), lithium difluoro(oxalato)borate (LIDFOB), lithium tris(pentafluoroethyl)trifluorophosphate LiPF₃(CF₂CF₃)₃ (LiFAP), ithium difluorophosphate LiPO₂F₂, and mixtures thereof.

The concentration of said at least one lithium salt can range from 0.75 to 1.5 mol·L⁻¹. Preferably, it ranges from 1 to 1.5 mol·L⁻¹. Even more preferably, it ranges from 1 to 1.2 mol·L⁻¹.

### Separator:

A separator is interposed between a positive and a negative electrode. The material of the separator can be chosen from the following materials: a polyolefin, e.g., polypropylene PP, polyethylene PE, a polyester, polymer-bonded glass fibers, polyimide, polyamide, polyaramide, polyamideimide and cellulose. The polyester may be selected from polyethylene terephthalate (PET) and polybutylene terephthalate (PBT). Advantageously, the polyester or polypropylene or polyethylene contains or is coated with a ceramic material selected from the group consisting of metal oxide, carbide, nitride, boride, silicide and sulfide. This ceramic material may be SiO₂ or Al₂O₃. The separator can be a ceramic-coated layer of polyolefin, preferably a layer of polyethylene coated on both sides with ceramic.

### Process for Manufacturing the Pouch Cell:

A method of manufacturing the pouch cell according to the invention will now be described.

In a first step, at least one positive electrode and at least one negative electrode are provided. The layers of compositions of positive and negative active materials have been deposited beforehand on their respective current collectors, taking care to reserve on an edge of the current collectors a strip which does not carry a layer of composition of active materials. This strip not covered with active materials will be used to make the weld with the current output terminal.

In a second step, the at least one positive electrode or the at least one negative electrode is wrapped with a separator. Preferably, the electrode having the largest surface is wrapped. This ensures that there is no portion at the periphery of an electrode that is not electrically insulated from the electrode of opposite polarity.

In a third step, the at least one positive electrode and the at least one negative electrode separated by a separator are stacked to obtain a plate pack. The at least one positive electrode and the at least one negative electrode are preferably oriented so that the strip not covered with a layer of active material composition of the positive electrode and the strip not covered with a layer of active material composition of the negative electrode are arranged on the same edge of the plate pack. A template may be used to center the at least one positive and the at least one negative electrode.

In a fourth step, the connection of the positive current output terminal to the strip not covered with a layer of composition of active materials of said at least one positive electrode and the connection of the negative current output terminal to the strip not covered with a layer of composition of active materials of said at least one negative electrode are performed. This connection can be made by laser welding or by resistance welding or by ultrasonic welding.

In a fifth step, a pouch is manufactured by welding several edges of two electrically insulating multilayer films, for example by heat-sealing three of the four edges of the two multilayer films. The plate pack is inserted inside the pouch.

The pouch is filled with an electrolyte. A vacuum may be created inside the pouch. Then the pouch is sealed, for example by heat-sealing.

The fifth step can be preceded by a preforming step of the two electrically insulating multilayer films. This preforming step consists in stamping the two electrically insulating multilayer films in order to create an impression of a positive electrode or a negative electrode on the surface of these two films. The electrode with the larger surface is chosen. Stamping can be carried out at room temperature using a hydraulic press. This step makes it possible to avoid the formation of wrinkles on the surface of the two multilayer films.

### Applications

The pouch cell according to the invention may be used to power one of the following flying vehicles: an electrically powered flying vehicle, a hybrid-electric-powered flying vehicle, or an aircraft using a 28 VDC bus system backed up by on-board batteries.

The categories of aircraft aimed at by the invention are airplane, rotorcraft, powered lift, glider, powered parachute, weight-shift control aircraft, and lighter than air.

The classes of aircraft aimed at by the invention are single-engine land, single-engine sea, multi-engine land, multi-engine sea, helicopter, gyroplane, powered-lift land, and powered-lift sea, airship, balloon, powered parachute land, powered parachute sea, weigh-shift-control aircraft land, and weigh-shift-control aircraft sea.

### EXAMPLES

Three pouch cells A, B and C all according to the invention were fabricated. The composition of both the positive and negative electrodes used in these cells is summarized in Table 1. The electrolyte composition in all cells was obtained by dissolving LiPF₆ at a concentration of 1 mol·L⁻¹ in a mixture of ethylene carbonate/propylene carbonate/ethyl methyl carbonate/dimethyl carbonate (EC/PC/EMC/DMC) mixed in the respective volume proportions of Oct. 20, 2025/45. Thereafter, vinylene carbonate (VC) and fluoroethylene carbonate (FEC) were added as additives in the proportions of 3% and 1% by mass respectively. The separator in all cells was a 9 μm polyethylene film coated on both sides by a 3 μm ceramic coating.

TABLE 1

| | | | Porosity of | Negative | |
|---|---|---|---|---|---|
| | | | the positive | electrode | Porosity of |
| | Cell capacity | Positive electrode | electrode | active | the negative |
| Cell | (Ah) | active material | (%) | material | electrode (%) |
| A | 21 | 50%/50% | 34 | 30% of modified | 27 |
| | | LiMn_{0.78}Fe_{0.22}PO₄/ | | artificial | |
| | | LiNi_{0.8}Mn_{0.1}Co_{0.1}O₂ | | graphite + 30% | |
| B | 21 | 40%/60% | 38.5 | of surface- | 28.5 |
| | | LiMn_{0.78}Fe_{0.22}PO₄/ | | coated modified | |
| | | LiNi_{0.8}Mn_{0.1}Co_{0.1}O₂ | | artificial | |
| C | 42 | 40%/60% | 38.5 | graphite + | 28.5 |
| | | LiMn_{0.78}Fe_{0.22}PO₄/ | | 40% of | |
| | | LiNi_{0.8}Mn_{0.1}Co_{0.1}O₂ | | highly pyrolytic | |
| | | | | graphite | |

TABLE 2

| | Specific energy | Percentage of the |
|---|---|---|
| | (Wh/kg) at C/5 | reference* discharged |
| Cell | rate | capacity (%) |
| B | 250 | C/5: 99 |
| | | C: 93 |
| | | 2C: 86 |
| C | 260 | C/5: 99 |
| | | C: 94 |
| | | 2C: 90 |

*The reference discharged capacity is measured at a discharge current of C/10.

Battery C was capable of being discharged at 25 °C under a high-power density of 1000 W/kg for 30 sec. pulses at different states of charge ranging from 100% down to a low state of charge of 20%. A low porosity in both the positive and the negative electrode allows reaching both a high specific energy of at least 250 Wh/kg and a high specific power of at least 1000 W/kg.

The capability of the cells to provide a high capacity even under a high discharge current was assessed. To this end, five cells of type B (B1-B5) and one cell of type C were discharged at 25 °C under various discharge currents of C/10, C/5, 1C and 2C, C being the cell nominal capacity. Each discharge was preceded by a charging step consisting of charging the cell at rate of C/5 until the voltage of 4.2 V was reached and then prolonging the charge until the charging current fell under C/50. The capacity discharged at a rate of C/10 was considered as the reference discharged capacity. The discharged capacity measured at a rate of C/5, 1C and 2C was compared to the reference discharged capacity and expressed as a percentage of the reference discharged capacity. FIG. 2 represents the percentage of the reference discharged capacity as a function of the discharge rate. Table 2 indicates the percentage of the reference discharged capacity as a function of the discharge rate. It is worth noting that this percentage remains above 85% for cells B and C even under a high discharge current of 2 C.

Cells A and B were placed in an oven and were progressively heated at a rate of +5 °C/min. The temperature of the batteries was monitored and any deformation of the cell pouch or any appearance of a venting was detected.

The tests results indicate that the maximum temperatures reached by cells A and B were 170 °C and 210 °C which values are within acceptable limits. Venting was observed in both cells when their temperature reached 121 °C. However, no thermal runaway or fire was observed. This situation corresponds to a level 4 in the EUCAR classification. It was observed that the addition of LMFP to the lithium nickel oxide allows reducing the amount of gas released during a thermal runaway and reducing the rate at which gas is released in comparison with a cell the positive electrode of which would contain only NMC 622 or NMC 811 as an active material.

1. An electrochemical pouch cell comprising at least one positive electrode and at least one negative electrode, wherein the positive electrode comprises a layer of a composition of positive active materials, said composition comprising a blend of:
a) from 30 to 50 wt. % of a lithium manganese iron phosphate of formula LiₓMn_{1-y-z}Fe_{y}M_{z}PO₄ where 0.8≤x≤1.2; 0.5≤(1-y-z)<1; 0<y≤0.5; 0≤z≤0.2;
M being selected from the group consisting of B, Mg, Al, Si, Ca, Ti, V, Cr, Co, Ni, Cu, Zn, Y, Zr, Nb, Mo, and mixtures thereof,
b) from 70 to 50 wt. % of at least one lithium nickel oxide selected from Li_{w}(NiₓCo_{y}Al_{z}Mₜ)O₂ where 0.9≤w≤1.1; 0<x; 0<y; 0<z; 0≤t; M being selected from the group consisting of B, Mg, Si, Ca, Ti, V, Cr, Mn, Fe, Cu, Zn, Y, Zr, Nb, W, Mo, and mixtures thereof and
Li_{w}(NiₓMn_{y}Co_{z}Mₜ)O₂ where 0.9≤w≤1.1; 0<x; 0<y; 0<z; 0≤t; M being selected from the group consisting of Al, B, Mg, Si, Ca, Ti, V, Cr, Fe, Cu, Zn, Y, Zr, Nb, W, Mo, and mixtures thereof, and wherein
the positive electrode porosity is less than or equal to 40%, and
the negative electrode porosity is less than or equal to 30%.

2. The electrochemical pouch cell according to claim 1, wherein the lithium nickel oxide is Li_{w}(NiₓMn_{y}Co_{z}Mₜ)O₂ with 0.7<x.

3. The electrochemical pouch cell according to claim 1, wherein secondary particles of the lithium nickel oxide have a first volume median diameter Dᵥ₅₀¹ and wherein secondary particles of the lithium manganese iron phosphate have a second volume median diameter Dᵥ₅₀², the ratio Dᵥ₅₀¹/Dᵥ₅₀² being from 2 to 9.

4. The electrochemical pouch cell according to claim 1, wherein the positive electrode comprises a current collector which is an aluminum foil or an aluminum alloy foil at least partially covered on one or both sides with a coating.

5. The electrochemical pouch cell according to claim 4, wherein the coating is made of a material selected from the group consisting of carbon, graphite, carbon nanotubes and a mixture thereof.

6. The electrochemical pouch cell according to claim 4, wherein the current collector has a thickness in the range of from 5 to 20 μm.

7. The electrochemical pouch cell according to claim 1, wherein the negative electrode comprises a current collector having a thickness in the range of from 3 to 10 μm.

8. The electrochemical pouch cell according to claim 1, wherein the layer of the composition of positive active materials contains one or more binders and/or one or more electronic conductive material and wherein the mass of said one or more binders represents 1% or less of the mass of the layer; the mass of said one or more electronic conductive material represents 1% or less of the mass of the layer.

9. The electrochemical pouch cell according to claim 1, wherein the layer of the composition of positive active materials contains carbon nanotubes.

10. The electrochemical pouch cell according to claim 1, wherein said at least one negative electrode comprises a layer of a composition of negative active materials, said composition comprising a blend of at least one anisotropically grown carbon with at least one isotropically grown carbon.

11. The electrochemical pouch cell according to claim 10, wherein the mass of the isotropically grown carbon represents from 10 to 60% or from 20 to 50% of the mass of the blend.

12. The electrochemical pouch cell according to claim 10, wherein the composition of negative active materials further comprises a silicon-based compound.

13. A battery comprising a plurality of electrochemical pouch cells according to claim 1.

14. A flying vehicle powered by the battery according to claim 13.

15. The flying vehicle according to claim 14 which is an electrically powered flying vehicle or a hybrid-electric-powered flying vehicle.

16. The electrically powered flying vehicle or the hybrid-powered flying vehicle of claim 15 selected from the group consisting of:
an electric vertical take-off and landing vehicle (e-VTOL),
an electric conventional take-off and landing vehicle (e-CTO), and
an electric short take-off and landing vehicle (e-STOL).

17. The flying vehicle according to claim 14 which is an aircraft.

18. The electrochemical pouch cell according to claim 2, wherein the lithium nickel oxide is Li_{w}(NiₓMn_{y}Co_{z}Mₜ)O₂ with 0.8≤x.

19. The electrochemical pouch cell according to claim 3, wherein the ratio Dᵥ₅₀¹/Dᵥ₅₀² is from 3 to 7.

20. The electrochemical pouch cell according to claim 6, wherein the current collector has a thickness in the range of from 10 to 16 μm.

21. The electrochemical pouch cell according to claim 7, wherein the negative electrode comprises a current collector having a thickness in the range of from 5 to 8 μm.
